(19) United States
(12) Patent Application Publication
(10) Pub. No.: US 2010/0254406 A1
(43) Pub. Date: Oct. 7, 2010

(54) QOS MANAGEMENT METHOD FOR AN ETHERNET BASED NGN

(75) Inventors: Ji-Wook Youn, Daejeon-city (KR); Byungjun Ahn, Daejeon-city (KR); Kyeong-Ho Lee, Daejeon-city (KR); Hae-Won Jung, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-city (KR)

(21) Appl. No.: 12/676,695

(22) PCT Filed: Sep. 5, 2008
(86) PCT No.: PCT/KR2008/005250

§ 371 Date: Mar. 5, 2010

(30) Foreign Application Priority Data
Sep. 6, 2007 (KR) 10-2007-0090550
Aug. 28, 2008 (KR) 10-2008-0084749

(51) Int. Cl. H04J 3/22

(52) U.S. Cl. 370/468

(57) ABSTRACT

Provided is a quality of service (QoS) management method in an Ethernet-based next generation network (NGN) including a plurality of Ethernet virtual connections (EVCs). A bandwidth is allocated to each of a plurality of frames based on classes of service (CoSs), physical ports, service types, and Layer 2 (L2)/Layer 3 (L3) information.

### TECHNICAL FIELD

The present invention relates to an Ethernet transport network for transmitting Ethernet frames, and more particularly, to a quality of service (QoS) management method in an Ethernet-based next generation network (NGN).

The present invention is derived from a research project supported by the Information Technology (IT) Research & Development (R&D) program of the Ministry of Knowledge Economy (MKE) and the Institute for Information Technology Advancement (IITA) [2006-S-061-02, Development of Technology on an IPv6-based QoS service and a terminal mobility supporting router].

### BACKGROUND ART

In a conventional Ethernet transport network, bandwidths are allocated and managed based on end customers of a virtual private network (VPN), or are differently allocated and managed according to virtual tunnels or priorities of virtual local area network (VLAN) tags. Thus, bandwidth allocation and quality of service (QoS) management may not be separately performed and, ultimately, the bandwidths are allocated based on priorities of Ethernet frames. Since a conventional bandwidth allocation method allocates the bandwidths based on the priorities of the Ethernet frames, sufficient QoS may not be provided.

FIG. 1 is a diagram for describing a conventional bandwidth allocation method in an Ethernet transport network. In particular, the conventional bandwidth allocation method of FIG. 1 is a method defined in “Ethernet Services Attributes Phase 2”, Metro Ethernet Forum (MEF) 10.1.

Referring to FIG. 1, a user-network interface (UNI) is an interface between end-customers and a network and includes a plurality of Ethernet virtual connections (EVCs).

In the conventional bandwidth allocation method, bandwidths are allocated based on a network interface, the EVCs of the network, or classes of service (CoSs) of Ethernet frames included in each EVC. Ultimately, in a conventional Ethernet transport network, the same bandwidth is allocated to Ethernet frames included in the same CoS and thus bandwidth allocation and QoS management may not be separately performed.

### DESCRIPTION OF THE DRAWINGS

FIG. 1 is a diagram for describing a conventional bandwidth allocation method in an Ethernet transport network;

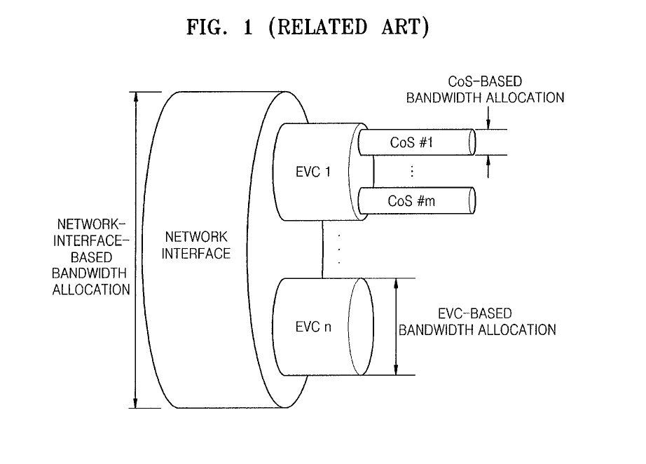

FIG. 2 is a block diagram of a connection-oriented Ethernet transport network according to an embodiment of the present invention;

FIG. 3 is a flowchart illustrating a method of transmitting Ethernet frames through the connection-oriented Ethernet transport network illustrated in FIG. 2, according to an embodiment of the present invention;

FIG. 4 is a diagram for describing a quality of service (QoS) management method in an Ethernet-based next generation network (NGN), according to an embodiment of the present invention;

FIG. 5 is a diagram for describing a QoS management method in an Ethernet-based NGN, according to another embodiment of the present invention; and

FIG. 6 is a flowchart illustrating a bandwidth allocation method, according to an embodiment of the present invention.

### DETAILED DESCRIPTION OF THE INVENTION

### Technical Solution

The present invention provides a method of efficiently utilizing an Ethernet-based next generation network (NGN), and providing different bandwidths and different qualities of service (QoSs) to Ethernet frames.

### Best Mode

According to an aspect of the present invention, there is provided a quality of service (QoS) management method in an Ethernet-based next generation network (NGN) including a plurality of Ethernet virtual connections (EVCs), the QoS management method including providing the same priority to frames that belong to an EVC having a single class of service (CoS); and allocating a bandwidth to each of the frames based on physical ports, service types, or Layer 2 (L2)/Layer 3 (L3) information.

According to another aspect of the present invention, there is provided a quality of service (QoS) management method in an Ethernet-based next generation network (NGN) including a plurality of Ethernet virtual connections (EVCs) between network interfaces, the QoS management method including providing the same priority to frames that belong to a network interface having a single class of service (CoS); and allocating a bandwidth to each of the frames based on the EVCs.

According to another aspect of the present invention, there is provided a quality of service (QoS) management method in an Ethernet-based next generation network (NGN) including a plurality of Ethernet virtual connections (EVCs) between network interfaces having a plurality of classes of service (CoSs), the QoS management method including providing the same priority to frames that belong to a single CoS; and allocating a bandwidth to each of the frames based on the EVCs.

### Advantageous Effects

According to the present invention, when Ethernet frames are transmitted through a connection-oriented transport network, different bandwidths and different QoSs may be simultaneously provided to the Ethernet frames by sorting the Ethernet frames based on Ethernet flows and allocating bandwidths to the Ethernet frames. In more detail, according to the present invention, bandwidths may be efficiently allocated to Ethernet frames when the Ethernet frames are transmitted through EVCs in an Ethernet transport network. Furthermore, the Ethernet frames to which the bandwidths are allocated may be differently controlled according to a policy of an operator and thus different QoSs may be provided to the Ethernet frames.

### MODE OF THE INVENTION

Hereinafter, the present invention will be described in detail by explaining embodiments of the invention with reference to the attached drawings.

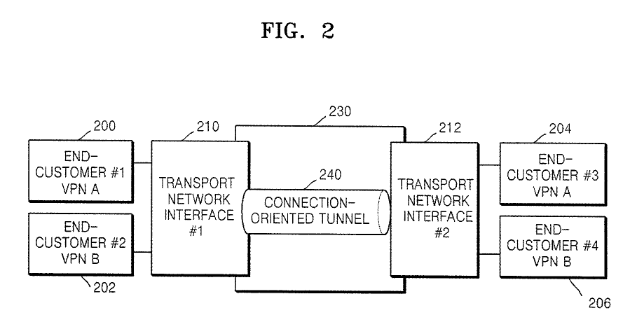

FIG. 2 is a block diagram of a connection-oriented Ethernet transport network 230 according to an embodiment of the present invention.

Referring to FIG. 2, end-customers compose different virtual private networks (VPNs). For example, the first and third end-customers 200 and 204 compose the VPN A, and the second and fourth end-customers 202 and 206 compose the VPN B. The VPNs A and B formed by the first through fourth end-customers 200, 202, 204, and 206 are connected to the connection-oriented Ethernet transport network 230 through first and second transport network interfaces 210 and 212. That is, the first transport network interface 210 sorts Ethernet frames input from an access network including the VPNs A and B, according to Ethernet flows, allocates bandwidths and qualities of service (QoSs) to the Ethernet frames, and transmits the Ethernet frames through the connection-oriented Ethernet transport network 230.

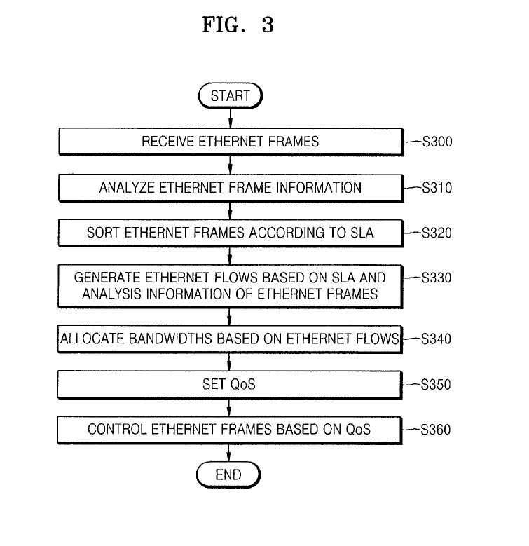

FIG. 3 is a flowchart illustrating a method of transmitting Ethernet frames through the connection-oriented Ethernet transport network 230 illustrated in FIG. 2, according to an embodiment of the present invention.

Referring to FIGS. 2 and 3, the first through fourth end-customers 200, 202, 204, and 206 included in an access network of the VPNs A and B access the connection-oriented Ethernet transport network 230 through the first and second transport network interfaces 210 and 212, and the first and second transport network interfaces 210 and 212 receive Ethernet frames from the first through fourth end-customers 200, 202, 204, and 206 of the access network, in operation S300.

The first and second transport network interfaces 210 and 212 analyze the Ethernet frames, in operation S310. In this case, information used to analyze the Ethernet frames includes end-customer interface (physical optical interface) information, service types, header information of the Ethernet frames (Layer 2 information), virtual local area network (VLAN) tag information, and Layer 3 (L3) information. If necessary, information on a Layer 4 (L4) or an upper layer of the L4 may be used.

The first and second transport network interfaces 210 and 212 sort the Ethernet frames according to a service level agreement (SLA) previously agreed by service providers and end-customers, in operation S320.

Then, the first and second transport network interfaces 210 and 212 generate Ethernet flows based on the SLA and analysis information of the Ethernet frames, in operation S330. Basically, the Ethernet flows are generated according to the SLA. In addition, the Ethernet flows may be generated according to the L2 information including destination and source addresses of the Ethernet frames, the end-customer physical optical interface information, the VLAN tag information, the service types, or the priority included in the L3 information.

The first and second transport network interfaces 210 and 212 allocate bandwidths based on the Ethernet flows, in operation S340. Also, the first and second transport network interfaces 210 and 212 set a QoS of each Ethernet frame based on the VLAN tag information, the service types, or the priority information included in the L3 information, in operation S350. The first and second transport network interfaces 210 and 212 set the QoS of an untagged Ethernet frame not having a VLAN tag, by using the L2 header information or an additional SLA. The first and second transport network interfaces 210 and 212 control and transmit the Ethernet frames through the connection-oriented Ethernet transport network 230, according to the QoS of each Ethernet frame, in operation S360.

Although FIGS. 2 and 3 are described with regard to a connection-oriented Ethernet transport network, FIGS. 2 and 3 may also be applied to other Ethernet-based next generation networks (NGNs).

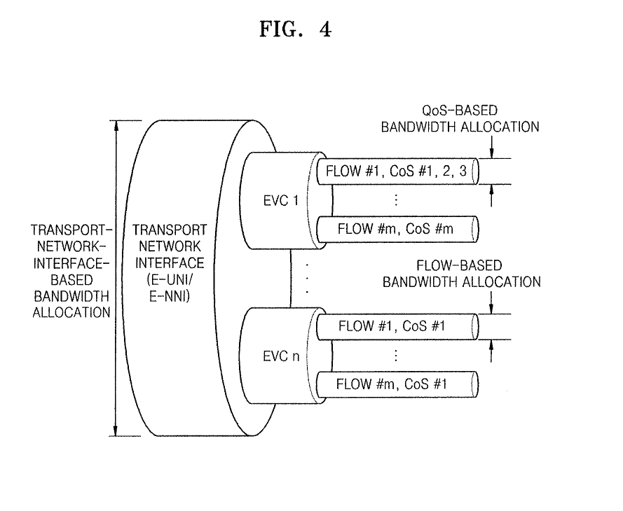

FIG. 4 is a diagram for describing a QoS management method in an Ethernet-based NGN, according to an embodiment of the present invention. Bandwidth allocation and QoS management may be separately performed using the QoS management method described with reference to FIG. 4 according to the current embodiment of the present invention, while bandwidth allocation and QoS management may not be separately performed using the conventional bandwidth allocation method.

Referring to FIG. 4, in the QoS management method according to the current embodiment of the present invention, bandwidths may be allocated based on a transport network interface, Ethernet virtual connections (EVCs), or Ethernet flows. In this case, the Ethernet flows may be defined based on a class of service (CoS) of each Ethernet frame, or regardless of the CoS. If the Ethernet flows are defined regardless of CoSs, all Ethernet frames included in an EVC have the same CoS and may have different bandwidths according to the Ethernet flows. In this case, the Ethernet flows are generated based on an SLA between service providers and end-customers, physical ports of the end-customers, L2 information (media access control (MAC) address information and VLAN tag information), service types, or L3 information (Internet protocol (IP) address information). On the other hand, if the Ethernet flows are defined based on the CoSs, the Ethernet flows have different QoSs from each other. In this case, a single Ethernet flow may include Ethernet frames having different CoSs from each other. According to the current embodiment of the present invention, the Ethernet frames transmitted through an EVC may be one of the following four types.

1. All Ethernet frames included in an EVC have the same bandwidth and the same priority.

2. All Ethernet frames included in an EVC have the same bandwidth. However, the Ethernet frames have different priorities based on QoSs.

3. Ethernet frames included in an EVC have different bandwidths. However, all Ethernet frames included in the same EVC have the same priority.

4. Ethernet frames included in an EVC have different priorities, and have different bandwidths based on the priorities.

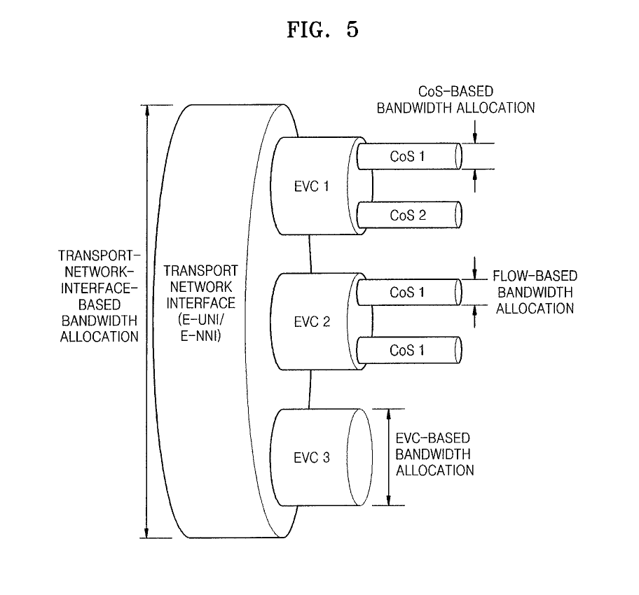

FIG. 5 is a diagram for describing a QoS management method in an Ethernet-based NGN, according to another embodiment of the present invention.

Referring to FIG. 5, a transport network interface may be an Ethernet user-network interface (E-UNI) or an Ethernet network-network interface (E-NNI). The E-UNI is the interface using an Ethernet frame structure between an Ethernet network and end-customers, and the E-NNI is the interface using the Ethernet frame structure between network providers. A plurality of EVCs exists between the transport network interfaces. Bandwidths may be allocated based on the E-UNI/E-NNI, the EVCs, QoSs, or Ethernet flows generated according to the physical ports, service types and L2/L3 header information. Thus, with regard to CoSs, each of the EVCs, the E-UNI, and the E-NNI may have four types as described below.

Initially, the EVCs may be one of the following four types.

1. A single CoS EVC: all frames that belong to an EVC are treated in the same way and are transported with equal bandwidth profile.

2. A single CoS EVC with multiple bandwidth profiles: frames that belong to an EVC are treated in the same way with same priority, but are transported with different bandwidth profile.

3. A multiple CoS EVC with single bandwidth profile: frames may be treated differently according to their CoSs, but all frames are transported with equal bandwidth profile.

4. A multiple CoS EVC with multiple bandwidth profile: frames are treated differently according to their CoSs, and frames are transported with CoS-designated bandwidth profile.

In the case of single CoS EVC with multiple bandwidth profile, input frames from the E-UNI are untagged frames that have the same priority, whereas bandwidth profile can be assigned based on physical ports, service types, or L2/L3 information.

The E-UNI may be one of the following four types.

1. A single CoS E-UNI: all frames belonging to the E-UNI are treated in the same way and are subjected to the same bandwidth profile.

2. A single CoS E-UNI with multiple bandwidth profile: frames that belong to an E-UNI are treated in the same way with same priority, but are transported with different bandwidth profile per EVC.

3. A multiple CoS E-UNI with a single bandwidth profile: frames may be treated differently according to their CoSs, but all frames are subjected to the same bandwidth profile.

4. A multiple CoS E-UNI with multiple bandwidth profile: frames are treated differently according to their CoSs, and frames belonging to a particular EVC are subjected to a single bandwidth.

The E-NNI may be one of the following four types.

1. A single CoS E-NNI: all frames belonging to the E-NNI are treated in the same way and are subjected to the same bandwidth profile.

2. A single CoS E-NNI with multiple bandwidth profiles: frames that belong to an E-NNI are treated in the same way with same priority, but are transported with different bandwidth profile per EVC.

3. A multiple CoS E-NNI with single bandwidth profile: frames may be treated differently according to their CoSs, but all frames are subjected to the same bandwidth profile.

4. A multiple CoS E-NNI with multiple bandwidth profiles: frames are treated differently according to their CoSs, and frames belonging to a particular EVC are subjected to a single bandwidth.

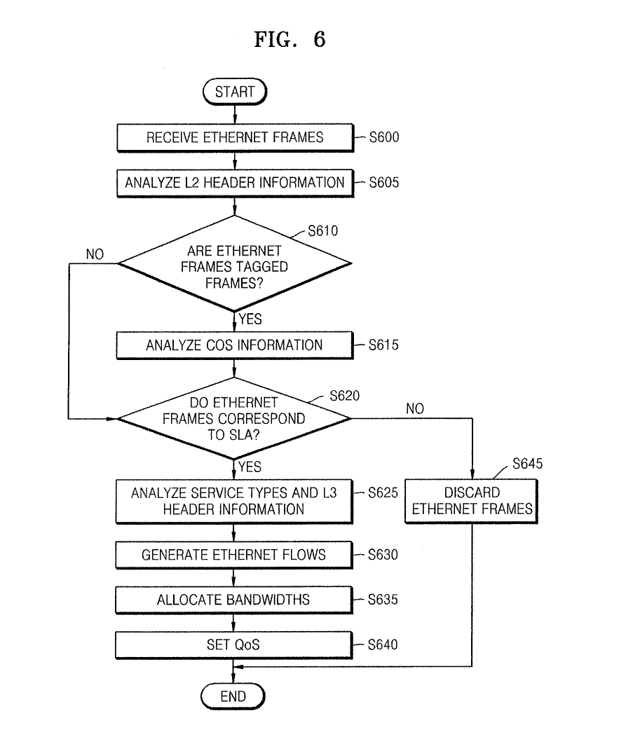

FIG. 6 is a flowchart illustrating a bandwidth allocation method, according to an embodiment of the present invention.

Referring to FIG. 6, a transport network interface receives Ethernet frames from a plurality of end-customers, in operation S600, and analyzes L2 header information of the Ethernet frames, in operation S605. By analyzing the L2 header information, if the Ethernet frames are tagged frames, in operation S610, the transport network interface analyzes CoS information so as to obtain priority information of the Ethernet frames in S615. The transport network interface determines whether the Ethernet frames input from the end-customers correspond to an SLA, in operation S620, Ethernet frames not corresponding to the SLA are discarded, in operation S645. Ethernet frames corresponding to the SLA are sorted by using the SLA. The transport network interface analyzes service types and L3 header information of the sorted Ethernet frames, in operation S625.

The transport network interface generates Ethernet flows of the sorted Ethernet frames by using end-customer physical optical interface information, the L2 header information, VLAN tag information, service types, and the L3 information, so as to input the Ethernet frames into corresponding Ethernet flows, in operation S630.

The transport network interface allocates bandwidths based on the Ethernet flows, in operation S635, and allocates new QoSs to be used in an Ethernet transport network, to the Ethernet frames that are sorted based on the Ethernet flows, in operation S640. In this case, the QoSs are allocated based on the Ethernet frames and Ethernet frames in the same Ethernet flow may have different QoSs from each other.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to preferred embodiments thereof, it will be understood by one skilled in the art that various changes in form and details may be made therein without departing from the spirit and scope of the invention as defined by the appended claims. The preferred embodiments should be considered in a descriptive sense only and not for purposes of limitation. Therefore, the scope of the invention is defined not by the detailed description of the invention but by the appended claims, and all differences within the scope will be construed as being included in the present invention.

1. A quality of service (QoS) management method in an Ethernet-based next generation network (NGN) comprising a plurality of Ethernet virtual connections (EVCs), the QoS management method comprising:
providing the same priority to frames in an EVC having a single class of service (CoS); and
allocating a bandwidth to each of the frames based on physical ports, service to types, or Layer 2 (L2)/Layer 3 (L3) information.

2. The QoS management method of claim 1, further comprising transmitting the frames using allocated bandwidths.

3. The QoS management method of claim 1, wherein the L2/L3 information comprises media access control (MAC) addresses and Internet protocol (IP) addresses.

4. A quality of service (QoS) management method in an Ethernet-based next generation network (NGN) comprising a plurality of Ethernet virtual connections (EVCs) between network interfaces, the QoS management method comprising:
providing the same priority to frames in a network interface having a single class of service (CoS); and
allocating a bandwidth to each of the frames based on the EVCs.

5. The QoS management method of claim 4, wherein the network interface is one of an interface using an Ethernet frame structure between end-customers and the Ethernet-based NGN, and an interface using the Ethernet frame structure between network providers.

6. The QoS management method of claim 4, further comprising transmitting the frames using allocated bandwidths.

7. The QoS management method of claim 4, wherein the allocating of the bandwidth to each of the frames comprises allocating different bandwidths to the EVCs.

8. A quality of service (QoS) management method in an Ethernet-based next generation network (NGN) comprising a plurality of Ethernet virtual connections (EVCs) between network interfaces having a plurality of classes of service (CoSs), the QoS management method comprising:
providing the same priority to frames in a single CoS; and
allocating a bandwidth to each of the frames based on the EVCs.

9. The QoS management method of claim 8, wherein the network interface is one of an interface using an Ethernet frame structure between end-customers and the Ethernet-based NGN, and an interface using the Ethernet frame structure between network providers.

10. The QoS management method of claim 8, further comprising transmitting the frames using allocated bandwidths.

11. The QoS management method of claim 8, wherein the allocating of the bandwidth to each of the frames comprises allocating the same bandwidth to frames in a predetermined EVC.
